(19) United States
(12) Patent Application Publication
(10) Pub. No.: US 2012/0280605 A1
(43) Pub. Date: Nov. 8, 2012

(54) Increased storage capacity door system

(76) Inventors: Robert Nettles, Klamath Falls, OR (US); David Ebsen, (US)

(21) Appl. No.: 13/068,235

(22) Filed: May 6, 2011

(51) Int. Cl. E06B 7/00

(52) U.S. Cl. 312/321.5

(57) ABSTRACT

A door and door frame system are disclosed in which a door is constructed with a thickness approximately equal to the thickness of the door frame and wall through which the associated doorway extends. The increased thickness is maintained for the width of the door and is used to provide additional storage within the door itself

### BACKGROUND

The present invention relates to a door storage system and more particularly to a door of enlarged internal storage volume created as the door is constructed with a thickness equivalent to that of the surrounding wall.

Conventional doors, depending upon whether they are “interior” doors or “exterior” doors have a thickness ranging from about 3.5 cm (1⅜ in) to about 4.5 cm (1¾ in) and occupy a portion of the thickness of the doorframe and/or surrounding wall. To these conventional doors, others have added storage compartments by adding additional thickness to a portion of the door while retaining the conventional door thickness in areas proximate the door frame. For example, U.S. Pat. No. 5,163,745 discloses a storage compartment added to a conventional door without occupying the full potential volume of storage in the door. The door appearance disclosed in U.S. Design Patent No. D607,578 also fails to utilize the full volume potentially available. As a consequence of this selective addition, not all of the potentially available volume of the door is made available for use in a storage application. Moreover, as the inventors of the present invention have come to realize, new problems arise when all of the available volume of a door within a doorframe is used for a storage application.

### BRIEF DESCRIPTION OF THE DRAWINGS

FIG. 1 is a perspective drawing of a door that may be employed in the present invention.

FIG. 2 is a cross section of one of the shelves of FIG. 1

FIG. 3 through 3-3 of the door of FIG. 1.

FIG. 4 is a partial cross sectional view of the door strike portion of the door of FIG. 3.

FIG. 5 is a partial cross sectional view of the door strike portion of the door of FIG. 3, illustrating an alternative embodiment.

FIG. 6 is an illustration of a storeroom use of the present invention.

FIG. 7 is an alternative cross section through the door of FIG. 3, illustrating an alternative embodiment.

FIGS. 8A and 8B are diagrams of two alternative door knob assemblies that may be employed in the present invention.

### DETAILED DESCRIPTION OF THE EMBODIMENTS

In many instances, physical storage space is at a premium. Closets and other domestic areas set aside for storage are often too small for all of the articles a household wishes to have put away or articles that may need unique or secure storage. Similar shortages of storage space also plagues commercial and other non-domestic locations.

One of the volumes that is underutilized in most locations is a volume in the proximity of doorways. Doorways are typically passages through walls that are about 11.5 cm to about 16.5 cm (4½ in to 6½ in) thick and the conventional door itself is only a fraction of this thickness. One embodiment of the present invention includes a door that is thicker than a conventional door: a thickness that is approximately equal to the thickness of the wall through which the associated doorway extends.

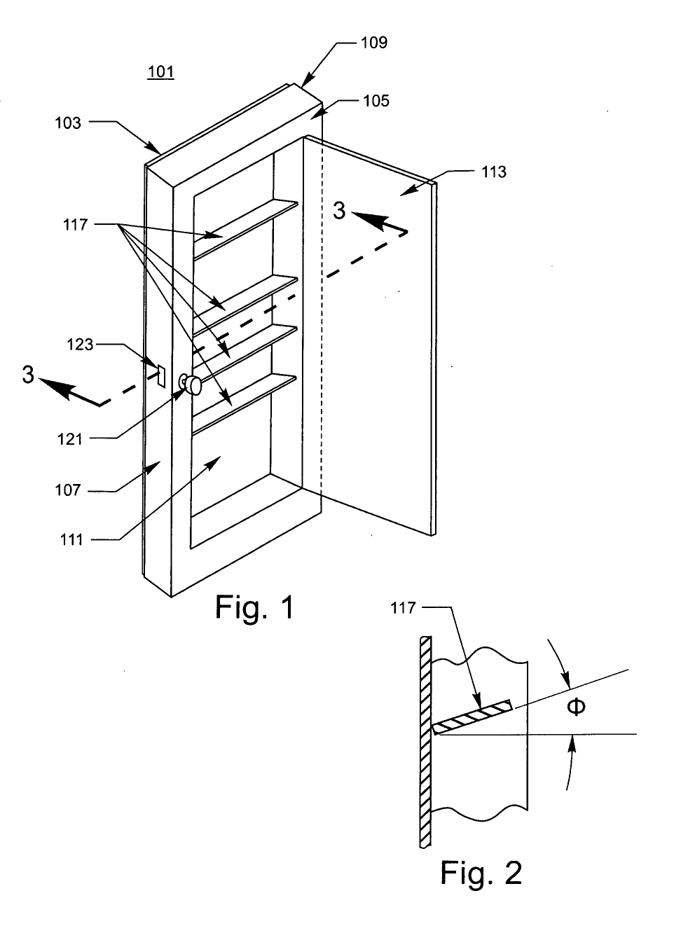

The increased thickness is advantageously used in the present invention to provide for additional storage within the door itself. The perspective view of FIG. 1 illustrates such a door that may be employed in the present invention. The door 101 includes (when viewed from the outwardly opening aspect of the door) a front side 103, a back side 105, a right side 107, and a left side 109, where the left side and the right side dimensions are approximately the thickness and height of the door. The internal volume of the door 111, which is left vacant, extends nearly to the edges of the door, except for the material comprising and making rigid the door.

FIG. 1 illustrates the door 101 as viewed from the back side 105, opening away from the viewer. The back side 105 includes a moveable panel 113, which, in one embodiment, is a secondary door that is smaller than the door 101, itself, and opens by pivoting around three or four cabinet hinges 115 to provide access to the interior open volume 111. The number and style of hinges depends upon the application and desired appearance of the secondary door. A plurality of shelves 117 or pockets or hooks or other supporting devices are affixed to the inside surface of the front side 103 such that items to be stored may be placed within easy reach of the user. In an alternative embodiment, the supporting devices may be affixed to the secondary door panel 113 or elsewhere within the interior volume. In another embodiment, the moveable panel 113 may be attached to the front side 103, thereby providing access from that side of the door 101.

Door 101 is preferably suspended from four 4 inch hinges 119 (which are not visible in the view of FIG. 1) that attach to a facing side jamb (not shown) of the door frame. The number of hinges and the vertical spacing between them depends, in a given installation, upon the application and expected weight of the items to be stored. In light duty applications as few as three hinges may be used, while in applications where heavy items are stored and/or where security is important, such as weapons storage applications, five or more hinges may be employed. Further, in heavy storage applications, a caster is installed at the bottom of the strike side of the door to support the additional weight. The door 101, the secondary door 113, and the remainder may be made of fire resistant materials to provide additional protection to the items stored. In one embodiment, the hinges are disposed nearest the front side 103 and left side 109 corner junction of the door 101 and away from the back side 105 and right side 107 corner junction or the back side 105 and left side 109 corner junction. The doorknob 121, having an accommodation to operate in a door with increased thickness, is conventionally disposed opposite the hinges 119 and is connected to the latch mechanism 123 disposed at right side 107. The door 101, therefore, pivots about the axis of the hinges as it is opened and closed.

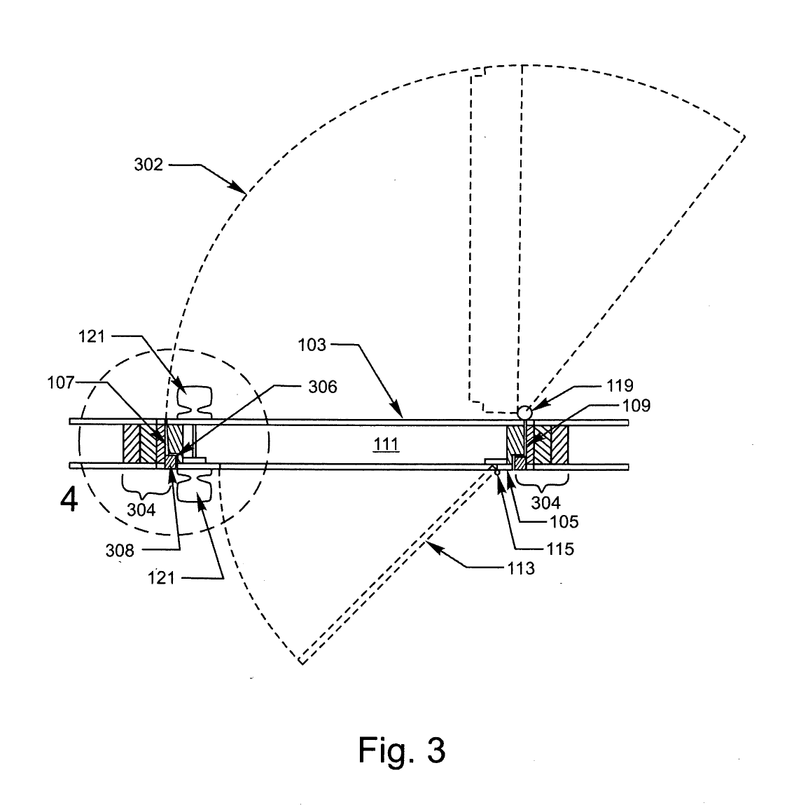

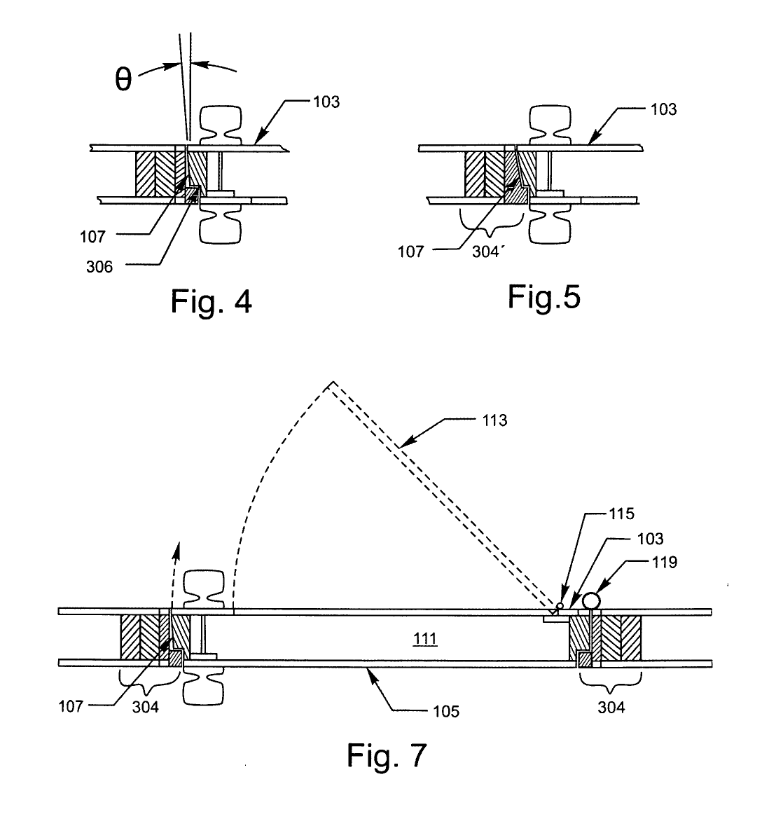

In contrast to a conventional door, the right side 107, as viewed in FIGS. 3 and 4 is beveled at an angle θ of about 7° with respect to a perpendicular to the plane of the front side 103 such that, given no other improvements, the front side 103 would be slightly larger in area than the back side 105. It is expected that angle θ may vary from 7° depending upon the clearance and fit required for individual door and trim applications. The major reason for the bevel can be perceived in the sectional drawings of FIG. 3. As the door 101 pivots about its hinges 119, it defines an arc 302 sweeping through the trajectory of the door 101 as it is opened and closed. An alternate embodiment employs a curved surface for the right side 107, where the curved surface is an arc section of about 11° of arc 302, approximately equal to the size of the arc subtended by the thickness of an 81 cm (32 in) wide door at the right side 107 edge. Under conventional conditions, the thickness of a 4.5 cm (1¾ in) door is such that the door pivoting through arc 302 easily clears the door jamb without interference. However, an increased door thickness to the full width of the wall, as taught for the present invention, yields a door that cannot reasonably swing through arc 302 without an interference with the door jamb or fit well enough to shut and lock properly. Previously configured door storage systems, such as those previously mentioned above, have not utilized the full width and height of the door for interior storage, preferring, instead, to utilize a smaller available volume as an addition to the center of the door and retain a normal door thickness at the door frame.

In one embodiment, where the door interior storage volume 111 extends from the structural member comprising right side 107 to the structural member comprising the left side 109. The right side 107 structural member is approximately 3.8 cm (1½ in) thick and 8.9 cm (3½ in) wide (conventional 2×4 lumber dimensions) and is preferably constructed of wood, although other suitable construction materials may be advantageously employed. The bevel reduces the structural member thickness dimensions only a small extent. The structural member comprising the front side 103 is preferably 1.25 cm (½ in) thick. The structural member comprising right side 107 further includes a door stop slot 306, running substantially the height of the right side 107 surface, terminates the pivoting motion of the door 101 when the door has been fully closed by butting against the stop member 308 of the door jamb. In one embodiment, the door stop slot 306 is disposed at the back side 105 of the door 101, thereby resulting in the area of the back side 105 of the door 101 being slightly smaller than the front side 103. The door stop slot is also disposed at the top of the door and the right side 109 of the door.

In one embodiment, the door jamb opposite the beveled left side 107 is conventionally arranged to be perpendicular to the plane of the front side 103 of the door 101. In an alternative embodiment, illustrated in the partial cross section of FIG. 5, the door jamb 304′ is arranged to be parallel to the beveled edge 107 of the door. That is, the door jamb 304′ and the door edge 107 are both beveled at an approximate 7° angle with respect to a perpendicular to the front side 103 of the door 101. Moreover, the stop member 308 is preferably integrally incorporated in the structural member forming the door jamb.

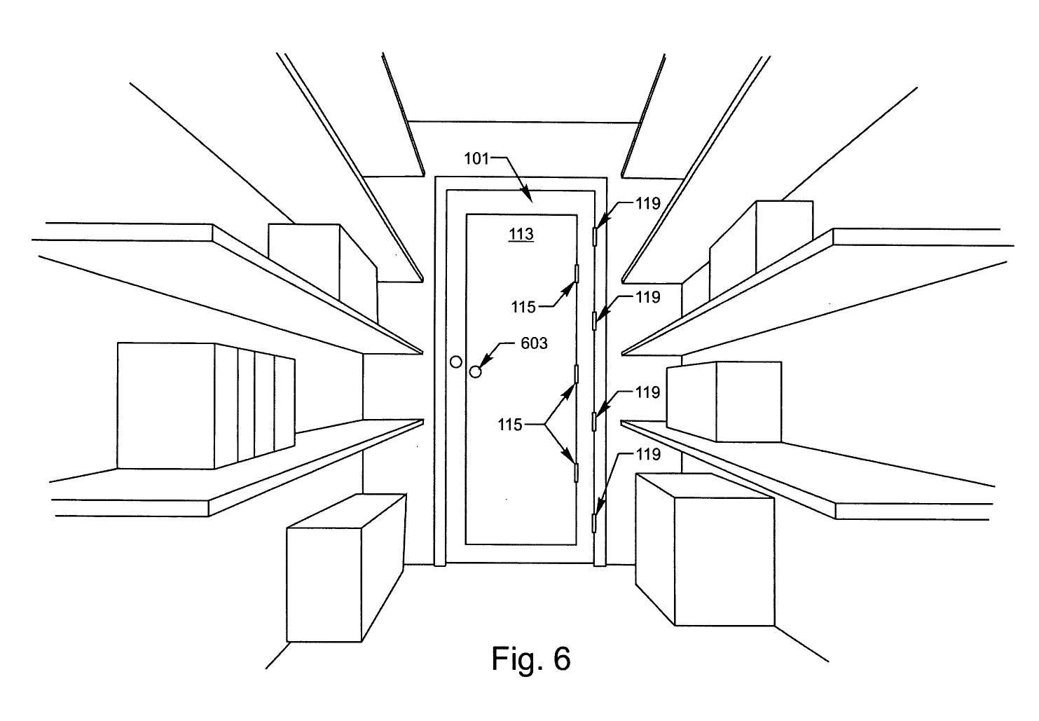

The interior of door 101 having conventional dimensions of 81 cm (32 in) width and 203 cm (80 in) height in a 11.5 cm (4½ in) thick wall provides interior storage volume 111 having dimensions of about 63 cm (24¾ in) width, 200 cm (78½ in) height, and 7.5 cm (3 in) thick. These dimensions, of course, are scalable for any doorway. Within the interior storage volume, one or more shelves 117 are placed to support the various items that are stored within the volume. The shelves are elevated at the front edge from level, as shown in FIG. 2, such that the flat top surface of the shelves slope downward at an angle φ of about 5° toward the inside of the back side 103. Additionally, depressions or cut-outs may be formed in the shelves to surround specific articles which may be placed on the shelves. Thus, items are caused to remain in place with reduced rattling as the door 101 is opened and closed and normal placement and removal of items is not unduly impeded. In one embodiment, a vacuum molded interior portion with preformed shelves or specialized fixtures is affixed within the interior storage volume, thereby providing the user with a customized storage area for unique items. For example but without limiting the uses, the storage area can be customized and used for weapons storage, office needs, bedroom storage (ties, shoes, belts, etc.), restroom and vanity items, entryways (umbrellas, coats, hats, etc.), recreation vehicle items storage, pantry, and so forth. The door 101 is shown in the diagram of FIG. 6 in an application of a storeroom, closet, or pantry, where a second latch mechanism and doorknob 603, opposite hinges 115, may be activated to open the secondary door 113 inwards to the storeroom to expose the additional storage within the door 101. A locking mechanism may be incorporated into the secondary latch mechanism.

Returning to the perspective drawing of FIG. 1 and the cross section of FIG. 3, the moveable panel 113 can be perceived with relation to the entirety of the door 101. The moveable panel 113 is a secondary door portion, smaller than the door 101 and mounted on separate hinges 115 such that the secondary door is capable of being opened independently of the door 101, itself. In one embodiment, the secondary door 113 opens to the inside of the door, as shown. This configuration is useful when the internal storage volume 111 is to be accessible from an internal area, such as the storeroom of FIG. 6. In an alternative embodiment, the secondary door 113 opens to the external, front side 103 of the door 101. Orientation of the door 101 components is similar to that of the inward-opening secondary door embodiment. The interior volume 111 is accessed upon the opening of the secondary door 113 about its hinges 115, as depicted in the cross section of the door 101 of FIG. 7. Hinges 115 are located between the back side 105 and the secondary door 113 and are disposed closer to the back side 105 and the right side 109 corner junction than the back side 105 and the left side 107 corner junction.

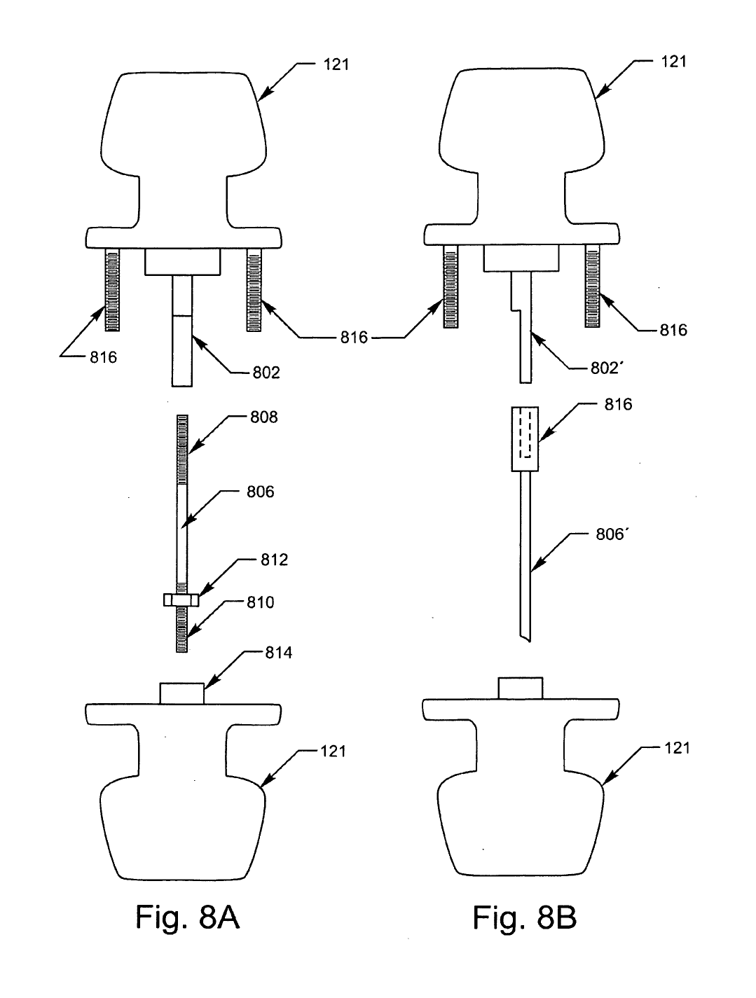

It can be perceived from FIG. 3, that the doorknob hardware conventionally available for a standard thickness door would be insufficient to operate in a door of the thickness required to practice the present invention. Doorknob hardware, described in its simplest form, comprises a grippable knob or equivalent mechanism 121 on each side of the door, operable by hand to rotate an internal shaft 802 about an axis of rotation defined by the center line of the shaft, and provide translation motion to a latch or bolt mechanism to pull a locking latch from a pocket in the door jamb, thereby to enable the door to open. The internal shaft 802 in a conventional door is of a length that reaches from one of the doorknobs 121, through the conventional rotation/translation motion converter that causes the moveable locking latch to retreat into the door, to the other of the doorknobs 121. Since the door 101 of the present invention is approximately four times as thick as a conventional door, a conventional internal shaft is too short to span the distance between doorknobs 121. In one embodiment a modified Quickset™ passage door latch is employed. The internal mechanism is extended to accommodate the additional thickness of the storage door. The extension is accommodated by a ½ in by 4 in end-tapered steel square stock shaft extender 806 that is threaded 808, 810 at each end, as shown in FIG. 8A. Each tapered end of shaft extender 806 inserts into square tubing 802 of the original Quickset™ door hardware. The threaded square stock provides for a ⅜ NC nut that is used as a depth stop 812. The depth stop and tapered end is affixed with an epoxy adhesive, or equivalent, to one end 814 of the square tube of the original door hardware. This allows for easier installation of the door latch extension. The extension and original door latch hardware is inserted into the door in the same manner as original hardware except that the hardware is secured through the wider door using 4 inch 8×32 threaded machine screws 816. Other brands of door hardware employ a keyed shaft 802′ to transmit the rotation from one doorknob to the other and pull the latch back. An extension shaft 806′ utilizes a bushing 816 with an interior opening that is keyed to the shaft 802′ of one doorknob 121 and affixed to a further keyed shaft that mates with the other doorknob 121. The assembly is secured together with the 4 inch 8×32 threaded machine screws 816.

Thus, a door storage system has been described and shown, which provides increased storage capacity over earlier designs and solves the problems associated with the increased storage volume.

We claim:

1. A door having height, width, and thickness dimensions and arranged to fit within a door frame, said door comprising:
a thickness dimension substantially equal to a thickness dimension of the door frame;
a first side and a substantially opposing second side, each side having the height dimension and substantially the thickness dimension;
a front side and an opposing back side, each having the height dimension and the width dimension;
a volume within the door bounded at least by said first side, said second side, said front side, and said back side, said volume useful to store articles;
one of said front side and said back side further comprising a moveable panel whereby said volume is accessible;
a hinge, having a pivot line, disposed on the door substantially at a corner junction of said front side and said first side, and oriented in a manner to place said hinge pivot line closer to said front side/first side corner junction than to a back side/first side or back side/second side corner junction; and
said second side forming an external substantially planar surface of the door and being oriented opposite a side jamb of said door frame when the door is closed, said second side beveled from a corner junction with said front side toward a corner junction between said back side and said second side such that an angle of about 7° is formed between a perpendicular to a plane defining said front side and the plane of said second side surface.

2. The door of claim 1 further comprising a moveable panel disposed in the plane of said back side and configured to move in a direction away from the plane of the back side, thereby exposing the interior volume of said door.

3. The door of claim 2 wherein said moveable panel is mounted on at least two hinges that are disposed closer to said back side/first side junction than said back side/second side junction.

4. The door of claim 1 further comprising a moveable panel disposed in the plane of said front side and configured to move in a direction away from the plane of the front side, thereby exposing the interior volume of said door.

5. The door of claim 4 wherein said moveable panel is mounted on at least two hinges that are disposed closer to said front side/first side corner junction than said front side/second side corner junction.

6. The door of claim 1 further comprising first and second door knobs disposed on said front side and said back side, respectively, and disposed closer to said second side than to said first side.

7. The door of claim 6 further comprising a shaft and a shaft extender, said shaft and said shaft extender extending substantially from said front side to said back side along an axis of rotation between the first and second doorknobs, said shaft extender further comprising first and second threaded ends.

8. The door of claim 1 further comprising a supporting device disposed within said volume, having at least one substantially flat surface, and affixed to said back side, upon which substantially flat surface said articles for storage are to be positioned, said substantially flat surface disposed within said volume at an angle of about 5° with respect to said back side.

9. The door of claim 1 further comprising a supporting device disposed within said volume, having at least one substantially flat surface, and affixed to said moveable portion, upon which substantially flat surface said articles for storage are to be positioned, said substantially flat surface disposed within said volume at an angle of about 5° with respect to said moveable portion.

10. A door and door frame system having height, width, and thickness dimensions and arranged to fit within a wall thickness, said system comprising:
a thickness dimension substantially equal to a thickness dimension of the wall;
a door comprising:
a first side and a substantially opposing second side, each side having the height dimension and substantially the thickness dimension,
a front side and an opposing back side, each having the height dimension and the width dimension,
a volume within the door bounded at least by said first side, said second side, said front side, and said back side, said volume useful to store articles, and
one of said front side and said back side further comprising a moveable panel whereby said volume is accessible;
a first door jamb member of the door frame disposed opposite said door first side;
a hinge, having a pivot line, affixed to the door substantially at a corner junction of said front side and said first side and affixed to said vertical door jamb member, said hinge oriented in a manner to place said hinge pivot line closer to said door front side/first side corner junction than to a door back side/first side or door back side/second side corner junction; and
a second door jamb member of the door frame disposed opposite said door second side when the door is closed, said second side forming an external substantially planar surface of the door, said second side beveled from a corner junction with said front side toward a corner junction between said back side and said second side such that an angle of about 7° is formed between a perpendicular to a plane defining said front side and the plane of said second side surface.

11. The system of claim 10 further comprising a moveable panel disposed in the plane of said door back side and configured to move in a direction away from the plane of said door back side, thereby exposing the interior volume of said door.

12. The system of claim 11 wherein said moveable panel is mounted on at least two hinges that are disposed closer to said back side/first side junction than said back side/second side junction.

13. The system of claim 10 further comprising a moveable panel disposed in the plane of said front side and configured to move in a direction away from the plane of the door front side, thereby exposing the interior volume of said door.

14. The system of claim 13 wherein said moveable panel is mounted on at least two hinges that are disposed closer to said door front side/first side corner junction than said door front side/second side corner junction.

15. The system of claim 1 further comprising first and second door knobs disposed on said front side and said back side, respectively, disposed closer to said second side than to said first side, and coupled to a rotation to translation converter, whereby the door is locked within the door frame.

16. The system of claim 15 further comprising a shaft and a shaft extender, said shaft and said shaft extender extending substantially from said front side to said back side along an axis of rotation between the first and second doorknobs, said shaft extender further comprising first and second threaded ends.

17. The system of claim 10 further comprising a supporting device disposed within said volume, having at least one substantially flat surface, and affixed to said back side, upon which substantially flat surface said articles for storage are to be positioned, said substantially flat surface disposed within said volume at an angle of about 5° with respect to said back side.

18. The system of claim 10 further comprising a supporting device disposed within said volume, having at least one substantially flat surface, and affixed to said moveable portion, upon which substantially flat surface said articles for storage are to be positioned, said substantially flat surface disposed within said volume at an angle of about 5° with respect to said moveable portion.
